(19) United States
(12) Patent Application Publication
(10) Pub. No.: US 2010/0155994 A1
(43) Pub. Date: Jun. 24, 2010

(54) APPARATUS AND METHOD FOR FABRICATING MOLDED CONTAINER USING COMPRESSION MOLDING MACHINE

(76) Inventors: Keun Seong Park, Gyeonggi-do (KR); Chris Han, Auckland (NZ)

Correspondence Address: PROSKAUER ROSE LLP, ONE INTERNATIONAL PLACE, BOSTON, MA, 02110, US

(21) Appl. No.: 12/161,123

(22) PCT Filed: Dec. 7, 2007
(86) PCT No.: PCT/KR2007/006338

§ 371 Date: Jul. 16, 2008

(30) Foreign Application Priority Data
Sep. 20, 2007 (KR) 10-2007-0096115
Sep. 20, 2007 (KR) 10-2007-0096120
Sep. 20, 2007 (KR) 10-2007-0096128
Sep. 20, 2007 (KR) 10-2007-0096130
Sep. 20, 2007 (KR) 10-2007-0096132
Sep. 20, 2007 (KR) 10-2007-0096134

(51) Int. Cl. B29C 43/56; B29C 43/34

(52) U.S. Cl. 264/325; 425/405.1; 425/352

(57) ABSTRACT

A method of fabricating a container using a compression molding machine is disclosed comprising supplying raw material into a hopper, which is disposed at one side of the compression molding machine; regulating the supply of the raw material by providing a pair of intercepting screens at the upper and lower portions, so that the intercepting screens can regulate the supply of the raw material by means of a gate cylinder; supplying the raw material to a lower mold so that the raw material introduced from the step of regulating the supply of the raw material is guided into the inside of a molding portion of the lower mold; and, separating and recovering the upper mold for elevating the upper mold from the transported upper and lower molds so that the upper mold can be returned to its initial position.

### RELATED APPLICATIONS

This application is the U.S. National stage of International Application No. PCT/KR2007/006338, filed on Dec. 7, 2007, in English, which claims priority to Korean Patent Application Nos. 10-2007-0096115, 10-2007-0096120, 10-2007-0096128, 10-2007-0096130, 10-2007-0096132, and 10-2007-0096134, all of which were filed on Sep. 20, 2007. The entire teachings of the above applications are incorporated herein by reference.

### FIELD OF THE INVENTION

The present invention relates to an apparatus and a method for fabricating a molded container using a compression molding machine, and more particularly, to an apparatus and a method for fabricating a molded container using a compression molding machine, in which a raw material is charged into a raw material supply device of the compression molding machine to automatically discharge and supply a molded container with a desired shape, thereby reducing the manufacturing cost, increasing commercial efficiency owing to quick release of the product to the market, and removing a problem of degraded quality due to occurrence of defective products to ensure excellence of quality of the product and improve workability and the like.

### BACKGROUND

As well known in the art, various domestic patent applications discuss a method of fabricating various kinds of containers and a molding machine to improve quality of the products used as a disposable product. For example, Korean patent application No. 1992-0027293 discloses a method of fabricating a good disposable container that fabricates a container by combining starch (such as potato and the like), liquid phase protein, and sodium phosphate with sawdust powder, rice husks, or rice straw powder to improve the jointing property, and then compression molding the combined product to thereby improve convenience in use.

However, a problem with such method is that a separate hardening agent or epoxy resin should be sprayed on the inner and outer surfaces of the container after the fabrication thereof because the above composition is weak to a jointing property between the materials and moisture.

Also, the process is complex because the molding process and the heating process are separate from each other. Specifically, the container is compression molded and then heated and hardened in a warm vaporizing device as described in the above patent application.

Korean patent application No. 2000-000032 discloses a plastic substitution material, which is produced by mixing a natural adhesive (such as potato starch) and coating agent (such as rosin) into an agricultural byproduct (such as rice husk) and wood byproduct (such as sawdust). However, although the modeling property of the composition is good, the binding force between the materials of the fabricated container and the elasticity of the container are deficient, such that the container can be easily damaged due to an external impact, and the like.

In addition, the above composition contains a large quantity of moisture prolonging the dry process, and thus increasing the manufacturing cost. The manufacturing cost is also increased due to the complexity of the production equipment. Specifically, the process of converting the starch into paste and the process of mixing the paste with bio-degradable material to thereby dry and pulverize the mixed composition are separately prepared. The bad product ratio increases according to the range of heating and pressurizing the composition at the time of molding, and the like.

Moreover, in addition to the prior filed Korean patent applications, there has been suggested an invention about a biodegradable composition and a container made of such bio-degradable composition, and the like. The bio-degradable composition is made of a composite material obtained by mixing vegetable material powder consisting essentially of rice husks with a biodegradable material including a binder. However, a disposable container fabricated from the above composition is deficient of binding force, and the process of fabricating is complex, thereby increasing the manufacturing cost because woven fabric or non-woven fabric was used as a reinforcement material.

In particular, since there has never been a molding device capable of mass-producing containers continuously by using a method of compression molding biodegradable material together with heating and pressurizing, it was impossible to largely commercialize the production of a composition for a disposable biodegradable container during development.

### SUMMARY OF THE INVENTION

Accordingly, the present invention solves the above problems of the conventional art, and an object of the present invention is to provide an automatic system, in which raw material is supplied to a raw material supply device of a compression molding machine constructed of upper and lower molds, and is compression molded by way of the compression between the upper and lower molds to thereby produce a molded container with a desired shape, and then the molded container is discharged automatically through a vacuum device arranged at one side.

Another object of the present invention is to provide an automatic system, in which upper and lower molds are constructed to recover to its original state by way of respective base guide rollers, so that the upper and lower molds can automatically mold the supplied raw material.

Still another object of the present invention is to provide an automatic system, in which the vacuum device for automatically discharging a molded container is constructed of a plurality of vacuum units, each is constructed of a plurality of vacuum nozzles disposed by one pair, so that the vacuum device can perform the vacuum suction more stably.

Still another object of the present invention is to provide a discharge guide roller at the upside of the vacuum device so that the vacuum device can continuously perform the discharge and suction.

To achieve the above objects, the present invention provides a method of fabricating a container using a compression molding machine, the method comprising the steps of: supplying raw material into a hopper, which is disposed at one side of the compression molding machine; regulating the supply of raw material by providing a pair of intercepting screens at the upper and lower portions to control a supply amount of the raw material so that the intercepting screens can regulate the supply of the raw material by means of a gate cylinder for supplying the raw material; supplying the raw material to a lower mold so that the raw material guided from the step of regulating the supply of the raw material is guided into the inside of a molding portion of the lower mold; and, separating and recovering of the upper mold for elevating the upper mold from the transported upper and lower molds so that the upper mold can return to its initial position.

Therefore, according to the present invention, following effects are obtained.

A raw material is charged into a raw material supply device of the compression molding machine to automatically discharge and supply a molded container with a desired shape, thereby reducing the manufacturing cost, increasing commercial efficiency owing to quick release of the product to the market, and removing a problem of degraded quality due to the occurrence of defective products to ensure excellence of quality of the product and improve workability and the like.

In addition, since biodegradable material consisting mainly of rice husks, sawdust, rice straw, and the like is used as raw material supplied into the compression molding machine, when the fabricated compression molded container is to be disposed as waste, it can be decomposed by microbes within a short time thereby being recycled as seed improving material, and the like, so that environment friendly effect and the like can be accomplished.

Although the present invention is described herein with reference to a preferred embodiment thereof, the present invention is not limited to the disclosed embodiments, and the present invention can be modified and changed variously without departing from the spirit and scope of the appended claims.

### BRIEF DESCRIPTION OF THE DRAWINGS

FIG. 1 is a block diagram showing a process of the present invention.

FIG. 2 is a view showing entire steps of the present invention.

FIG. 3 is a view showing a step of charging raw material into a raw material supply device.

FIG. 4 is a view showing a circulating operation state of a lower mold.

FIG. 5 is a view showing a circulating operation state of an upper mold.

FIG. 6 is a view showing an operation state in which a container is molded by using a press device.

FIG. 7 is a view showing an operation state in which a container is discharged through a vacuum discharge device.

FIG. 8 is a view showing a joint state of a geared motor and a chain sprocket of the lower mold.

FIG. 9 is a view showing an operation state of upper and lower operating cylinders of the lower mold in which the lower mold is ascended.

FIG. 10 is a view showing an operation state of upper and lower operating cylinders of the lower mold in which the lower mold is descended.

FIG. 11 is a view showing a side joint of an upper mold.

FIG. 12 is a view showing an operation state in which the upper mold is operated by a molding device guide cylinder.

FIG. 13 is a view showing an operation state in which the upper mold is elevated up and down by an elevation cylinder of the upper mold.

FIG. 14 is a view showing a state of vacuum suction from the lower mold.

FIG. 15 is a view showing a descending state of the lower mold.

FIG. 16 is a view showing a transporting state of the vacuum unit to one side.

FIG. 17 is a view showing a state in which the molded container is vacuum released from the vacuum unit.

FIG. 18 is a view showing a state in which the vacuum unit is recovered and the molded container is discharged to a discharge conveyor.

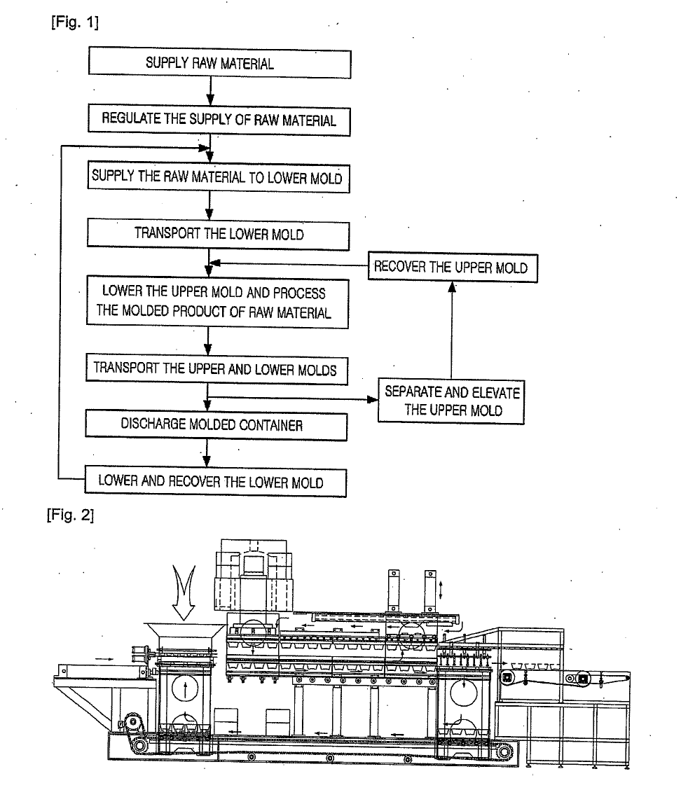

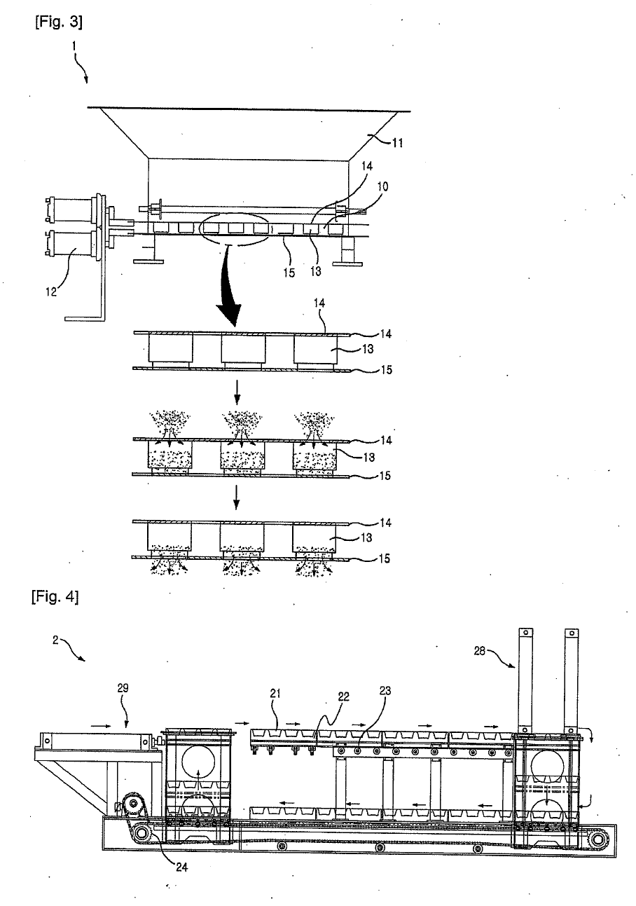

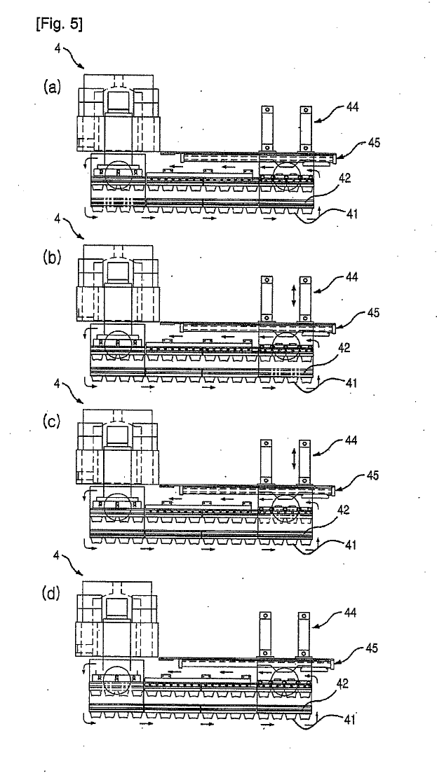

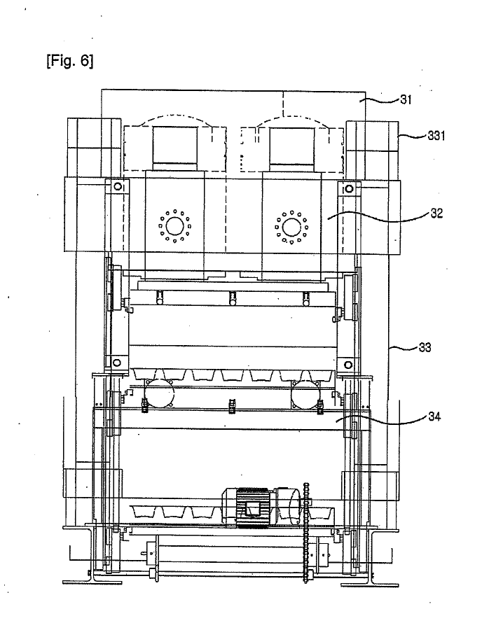

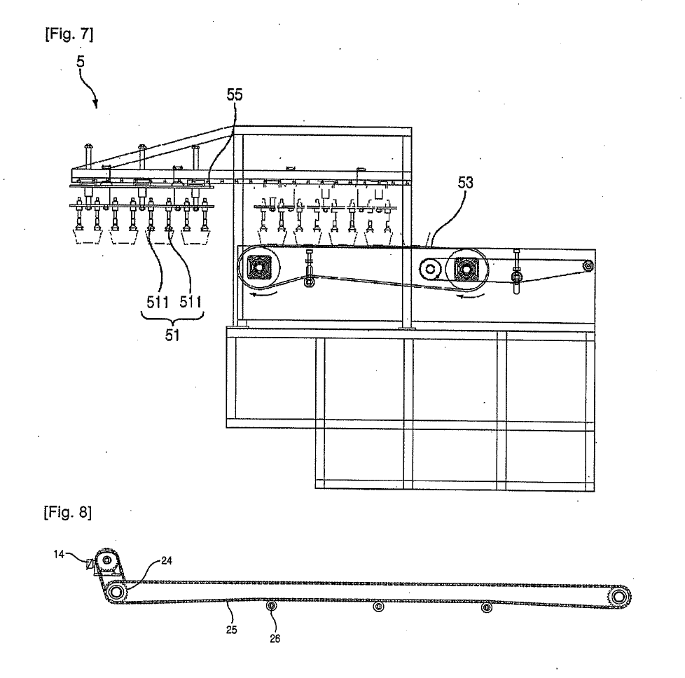

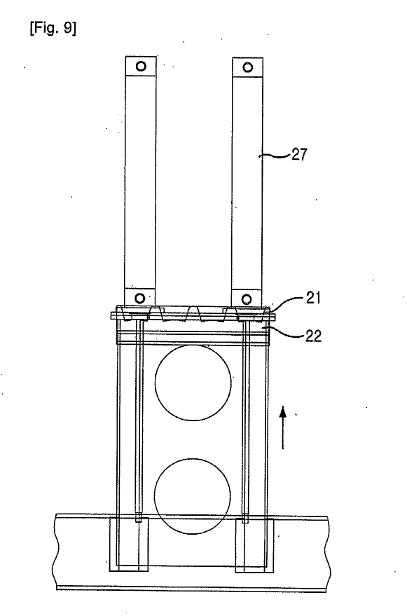

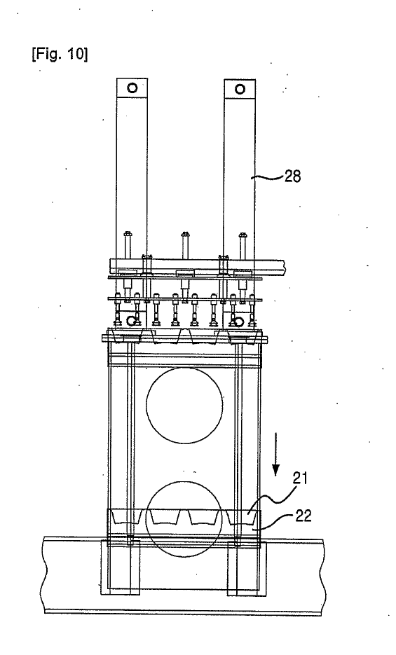

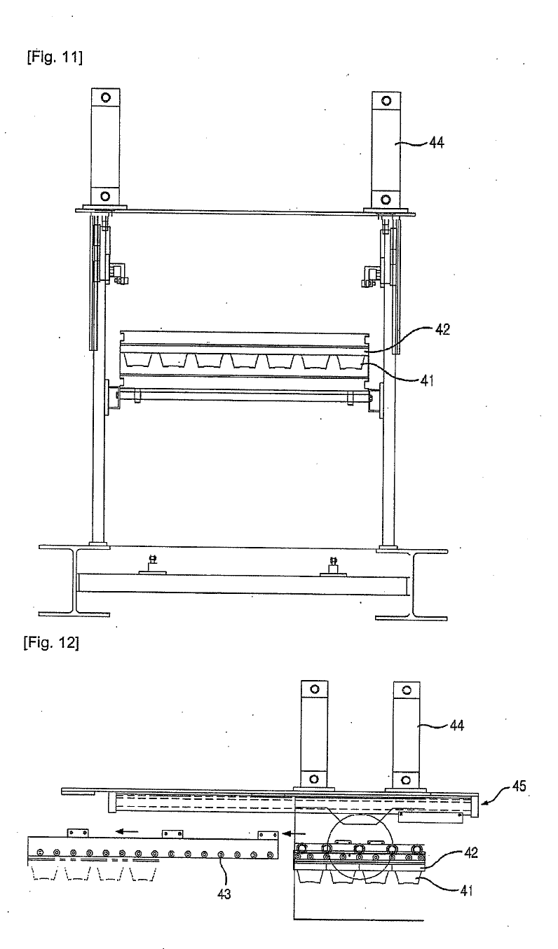

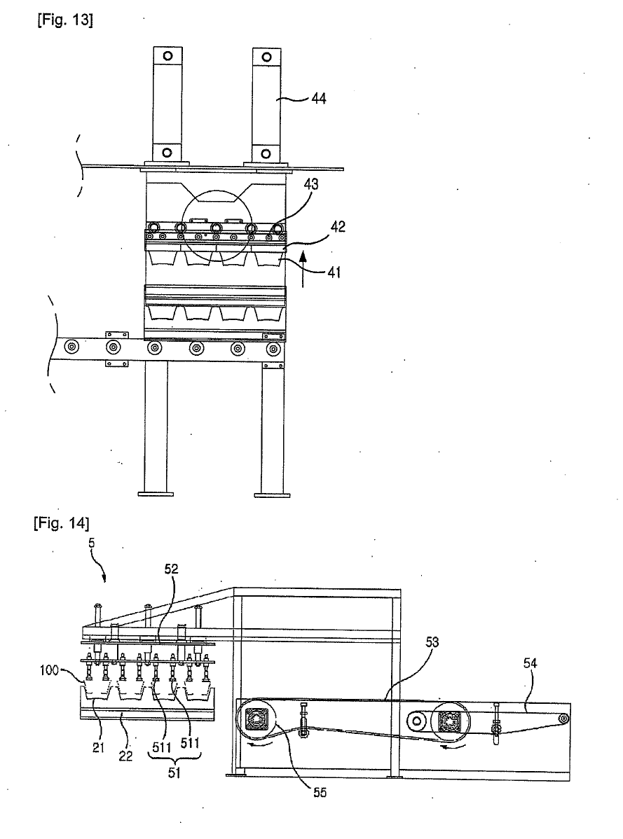

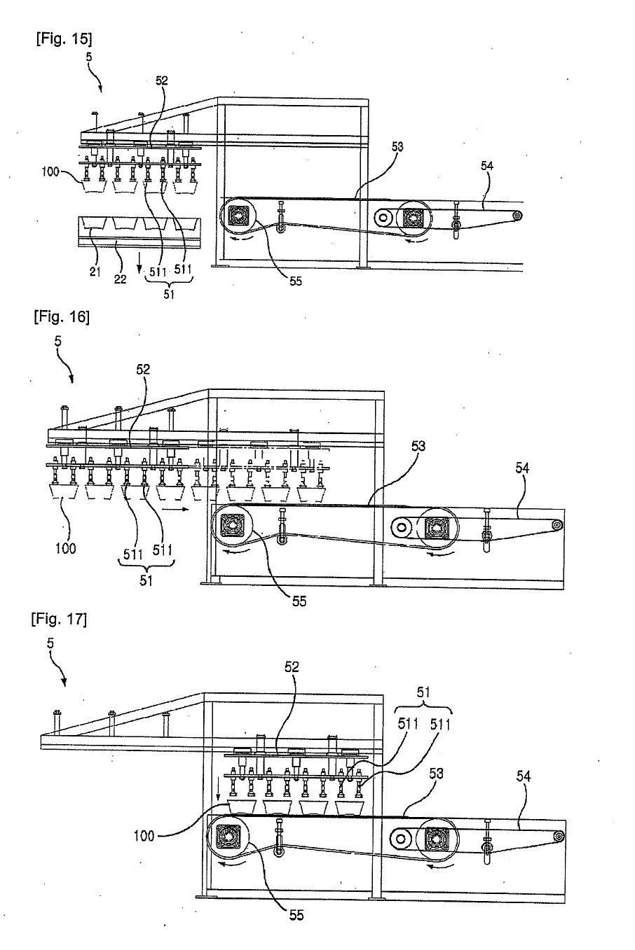

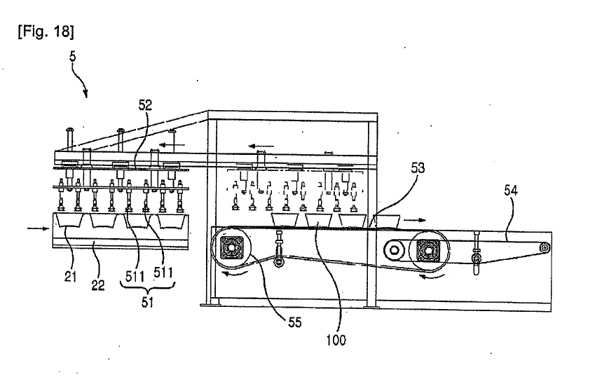

### DETAILED DESCRIPTION

Hereinafter, the preferred embodiment of the present invention will be described in detail with reference to the appended drawings.

According to one embodiment of the present invention, there is provided a method of fabricating a container using a compression molding machine, comprising the steps of supplying raw material into a hopper 11, which is disposed at one side of the compression molding machine; regulating the supply of raw material by providing a pair of intercepting screens 14 and 15 at the upper and lower portions to control a supply amount of the raw material so that the intercepting screens 14 and 15 can regulate the supply of the raw material by means of a gate cylinder 12 for supplying the raw material; supplying the raw material to a lower mold so that the raw material guided from the step of regulating the supply of the raw material is guided into the inside of a molding portion of the lower mold 21; transporting the lower mold 21, which is supplied of the raw material, by one pitch by using a base roller 23 of the lower mold; working the raw material by lowering an upper mold 41 to the upper side of the lower mold 21, which is transported by one pitch, to thereby compression mold the raw material positioned at the molding portion of the lower mold 21; transporting the upper and lower molds 21, 41 along respective base rollers 23 and 43 of the upper and lower molds in sequence; and, discharging a molded container 100 by separating the molded container from the transported upper and lower molds 21 and 41 and discharging it.

According to another embodiment of the present invention, there is provided an apparatus for fabricating a molded container using a compression molding machine (A), in which a hopper 11 is provided at one side of the compression molding machine (A) and a pair of upper and lower intercepting screens 14 and 15 are provided to regulate supply amount of the raw material supplied to the hopper 11 by using a gate cylinder 12 provided at one side thereof, and wherein a lower mold 21 for receiving the raw material and an upper mold 41 for compression molding the raw material are respectively installed to mounting bases 22 and 42 of the lower and upper molds and transported along base rollers 23 and 43 installed respectively at the lower and upper portions in sequence, so that the molded container 100 can be separated from the upper and lower molds 21 and 41 by using a vacuum device 5 installed at the other side thereof.

The present invention can further comprise steps of separating and recovering the upper mold, in which the upper mold 41 is elevated to the upside from the transported upper and lower molds 21 and 41 and returned to its initial state along the base roller 43 of the upper mold, and discharging a molded product by using a vacuum device 5, in which the molded container 100 supplied to the lower mold 21 is separated from the lower mold 21 and discharged by the vacuum device 5.

In addition, the present invention may further comprise steps of providing a base roller 23 for the lower mold at one side of the lower mold 21 so that the lower mold 21 is returned to its initial position by the base roller 23, and wherein the molded container 100 discharged at the discharging step of the molded container is sequentially discharged by a discharge conveyor 53.

Meanwhile, the vacuum device 5 may comprise a plurality of vacuum units 51. Each vacuum unit is constructed of a pair of vacuum nozzles 511, and is guided to the lower side of the upper mold 41 after automatically transporting the lower mold 21 by one pitch, which is supplied of the raw material by a gate cylinder 12 for supplying the raw material.

As described above, according to the present invention, it is possible to realize a large commercialization due to the development of biodegradable disposable container composition, which can produce containers continuously by a method of compression molding biodegradable material together with heating and pressurizing.

In addition, it is possible to reduce the manufacturing cost, increase commercial efficiency owing to quick release of the product to the market, and remove the problem of degraded quality due to occurrence of defective products to ensure excellence of quality of the product.

### REFERENCE LABELS

A: compression molding machine
1: raw material supply device
2: lower mold transporting device
3: press device
4: upper mold transporting device
5: vacuum device
10: raw material supply device
11: hopper
12: raw material supply gate cylinder
13: raw material supply tank
14: upper interception screen
15: lower interception screen
21: lower mold
22: installation base of lower mold
23: base roller of lower mold
24: chain sprocket
25: chain
26: chain guide roller
28, 44: upper and lower operation cylinder
29: molding device guide cylinder
34: lower body of the compression molding cylinder
41: upper mold
42: installation base of upper mold
43: base roller of upper mold
45: upper mold molding device guide cylinder
51: vacuum unit
53: ship
54: discharge conveyor
55: discharge device guide roller
100: molded container
511: vacuum nozzle
M: geared motor

1. A method of fabricating a container using a compression molding machine comprising:
supplying raw material into a hopper disposed at one side of the compression molding machine;
regulating the supply of raw material by providing a pair of upper and lower intercepting screens, the intercepting screens being controlled by a gate cylinder;
supplying the raw material to a lower mold, such that the raw material is guided into the inside of a molding portion of the lower mold;
lowering an upper mold into the lower mold to compression mold the raw material positioned at the molding portion of the lower mold; and
separating and recovering of the upper mold by elevating the upper mold from the lower mold.

2. An apparatus for fabricating a molded container using a compression molding machine comprising:
a hopper provided at one side of the compression molding machine;
a gate cylinder controlling a pair of upper and lower intercepting screens to regulate a supply amount of the raw material supplied to the hopper;
a lower mold for receiving the raw material and an upper mold for compression molding the raw material, the lower and upper models being respectively installed to mounting bases and transported along base rollers installed respectively at the lower and upper portions in sequence, the molded container being separated from the upper and lower molds using a vacuum device installed at an opposing side of the compression molding machine.

3. The method according to claim 1, further comprising discharging a molded product by using a vacuum device to separate a molded container from the lower mold 21.

4. The method according to claim 3, further comprising providing a base roller for the lower mold at one side of the lower mold so that the lower mold is returned to its initial position by the base roller.

5. The method according to claim 4, further comprising sequentially discharging the molded container using a discharge conveyor.

6. The apparatus according to claim 2, wherein the vacuum device comprises a plurality of vacuum units, each vacuum unit comprising a pair of vacuum nozzles.

7. The apparatus according to claim 2, wherein the lower mold is guided to the lower side of the upper mold after being automatically transported by one pitch, after being supplied of the raw material by a gate cylinder.

8. A method of fabricating a container, comprising:
transporting an upper mold and a lower mold for a plurality of containers continuously through a plurality of stages along respective upper and lower conveyer systems;
at a first stage, supplying raw material to an interior portion of the lower mold;
at a second stage, engaging an upper mold into the interior portion of the lower mold to perform compression molding of the raw material into a plurality of containers;
at the third stage, disengaging the upper mold from the lower mold; and
at a fourth stage, discharging the plurality of containers from the lower mold.

9. The method of claim 8 further comprising:
after discharging the plurality of containers, transporting the lower mold along the lower conveyer system back to the first stage.

10. The method of claim 8 further comprising:
after disengaging from the lower mold, transporting the upper mold along the upper conveyer system back to the second stage.

11. The method of claim 8, wherein compression molding comprises heating and pressuring the raw material.

12. The method of claim 8, wherein the raw material is a biodegradable material.

13. An apparatus for fabricating a container, comprising:
means for transporting an upper mold and a lower mold for a plurality of containers continuously through a plurality of stages;
at a first stage, means for supplying raw material to an interior portion of the lower mold;
at a second stage, means for engaging an upper mold into the interior portion of the lower mold to perform compression molding of the raw material into a plurality of containers;
at the third stage, means for disengaging the upper mold from the lower mold; and
at a fourth stage, means for discharging the plurality of containers from the lower mold.
